(19) United States
(12) Patent Application Publication
(10) Pub. No.: US 2020/0033503 A1
(43) Pub. Date: Jan. 30, 2020

(54) Alternating Current Coupled Accelerometer Calibration

(71) Applicant: PGS Geophysical AS, Oslo (NO)

(72) Inventors: Stian Hegna, Oslo (NO); Mattias Südow, Kista (SE)

(73) Assignee: PGS Geophysical AS, Oslo (NO)

(21) Appl. No.: 16/488,313

(22) PCT Filed: Feb. 23, 2018
(86) PCT No.: PCT/EP2018/054472

§ 371 Date: Aug. 23, 2019

Related U.S. Application Data
(60) Provisional application No. 62/462,742, filed on Feb. 23, 2017.

(51) Int. Cl. G01V 13/00; G01V 1/16; G01V 1/18; G01V 1/38

(52) U.S. Cl. CPC G01V 13/00; G01V 1/38; G01V 1/186; G01V 1/164

(57) ABSTRACT

Alternating current (AC) coupled accelerometer calibration can include acquiring calibrated data from a direct current (DC) coupled accelerometer of a towed object and interpolating the acquired calibrated data to a location of an AC coupled accelerometer of the towed object. AC coupled accelerometer calibration can also include estimating a calibration parameter associated with the AC coupled accelerometer based on the interpolating and correcting for a sensitivity associated with the AC coupled accelerometer using the calibration parameter.

### CROSS-REFERENCE TO RELATED APPLICATIONS

This application is a National Stage Application under 35 USC § 371 of International Application No. PCT/EP2018/054472, filed on Feb. 23, 2018 and published as WO Publication No. 2018/154037 on Aug. 30, 2018, which claims the benefit of U.S. Provisional Application 62/462,742, filed Feb. 23, 2017, which is incorporated by reference in its entirety.

### BACKGROUND

In the past few decades, the petroleum industry has invested heavily in the development of marine survey techniques that yield knowledge of subterranean formations beneath a body of water in order to find and extract valuable mineral resources, such as oil. High-resolution images of a subterranean formation are helpful for quantitative interpretation and improved reservoir monitoring. For a typical marine survey, a marine survey vessel tows one or more sources below the sea surface and over a subterranean formation to be surveyed for mineral deposits. Receivers can be located on or near the seafloor, on one or more streamers towed by the marine survey vessel, or on one or more streamers towed by another vessel. The marine survey vessel typically contains marine survey equipment, such as navigation control, source control, receiver control, and recording equipment. The source control can cause the one or more sources, which can be air guns, marine vibrators, electromagnetic sources, etc., to produce signals at selected times. In some instances, each signal is essentially a wave called a wavefield that travels down through the water and into the subterranean formation. At each interface between different types of rock, a portion of the wavefield can be refracted, and another portion can be reflected, which can include some scattering, back toward the body of water to propagate toward the sea surface. The receivers thereby measure a wavefield that was initiated by the actuation of the source. In some instances, each signal is essentially a wavefield that is imparted into the subterranean formation, which can induce a different wavefield in response. The receivers can measure the different wavefield that was induced by the actuation of the source.

### BRIEF DESCRIPTION OF THE DRAWINGS

FIG. 1 illustrates an elevation or xz-plane view of marine surveying in which signals are emitted by a source for recording by receivers for processing and analysis in order to help characterize the structures and distributions of features and materials underlying the surface of the earth.

FIG. 2 illustrates an exemplary embodiment of a method flow diagram for alternating current (AC) coupled accelerometer calibration.

FIG. 3 illustrates an exemplary embodiment of a method flow diagram for AC coupled accelerometer calibration.

FIG. 4 illustrates an exemplary embodiment of a method flow diagram for AC coupled accelerometer calibration.

FIG. 5 illustrates a diagram of an exemplary embodiment of a system for AC coupled accelerometer calibration.

FIG. 6 illustrates a diagram of an exemplary embodiment of a machine for AC coupled accelerometer calibration.

FIG. 7 illustrates a bottom view of various sections of a towed object.

FIGS. 8A and 8B illustrate diagrams of results of an example physical experiment for AC coupled accelerometer calibration.

FIGS. 9A and 9B illustrate diagrams of results of an example physical experiment for AC coupled accelerometer calibration.

FIGS. 10A and 10B illustrate diagrams of results of an example physical experiment for AC coupled accelerometer calibration.

FIG. 11 illustrates a diagram of results of an example physical experiment for AC coupled accelerometer calibration.

FIG. 12 illustrates a diagram of results of an example physical experiment for AC coupled accelerometer calibration.

FIG. 13 illustrates a diagram of results of an example physical experiment for AC coupled accelerometer calibration.

FIGS. 14A and 14B illustrate diagrams of results of an example physical experiment for AC coupled accelerometer calibration.

### DETAILED DESCRIPTION

This disclosure is related generally to the field of marine surveying. Marine surveying can include, for example, seismic surveying or electromagnetic surveying, among others. During marine surveying, one or more sources are used to generate wavefields, and receivers (towed and/or ocean bottom) receive energy generated by the sources and affected by the interaction with a subsurface formation. The receivers thereby collect survey data, which can be useful in the discovery and/or extraction of hydrocarbons from subsurface formations.

A towed object, such as a source, a receiver, or a streamer, may be towed behind a marine survey vessel to collect the survey data. A streamer can be a marine cable assembly that can include receivers and electrical or optical connections to transmit information collected by the receivers to the marine survey vessel. The streamer can include receivers such as seismic receivers (e.g., hydrophones, geophones, etc.) or electromagnetic receivers. The towed object can include AC coupled accelerometers or other particle motion sensors that have particular orientations, and/or may be calibrated. For instance, the present disclosure is related to calibrating an AC coupled accelerometer. Calibrating an AC coupled accelerometer, as used herein, can include correcting for sensitivities or other parameters associated with the AC coupled accelerometer.

Some towed objects, including streamers, for instance, can use gimbal-mounted AC coupled accelerometers, which can rotate about a single axis. Gimbal-mounted AC coupled accelerometers can be mechanically complicated, which can result in limitations during recording, particularly during mechanical failures of the gimbal-mounted AC coupled accelerometers. For instance, limitations can include reduced results reliability and higher cost due to the complexity of sensors of the AC coupled accelerometers and mechanical repair costs, among others.

In contrast, at least one embodiment of the present disclosure includes a rigidly-mounted AC coupled accelerometer. In at least one embodiment, the AC coupled accelerometer is an AC coupled piezoelectric accelerometer. As used herein, an AC coupled accelerometer detects particle displacement within water by detecting particle motion variation, such as accelerations. A rigidly-mounted AC coupled accelerometer is lighter-weight, improves result reliability, and is less expensive as a result of being mechanically simpler as compared to gimbal-mounted AC coupled accelerometers. An AC coupled accelerometer, as used herein, is highly sensitive and can measure down to 0.1 Hertz. An AC coupled accelerometer has a wider frequency response and higher signal-to-noise ratio as compared to non-AC coupled accelerometers or other particle motion sensors.

At least one embodiment of the present disclosure includes a DC coupled accelerometer to compliment the AC coupled accelerometer. As used herein, a DC coupled accelerometer includes a sensor with an output characteristic that measures a signal with a zero Hertz frequency content. For example, a DC coupled accelerometer can measure a signal having a steady acceleration like the Earth's gravity. As used herein, an AC coupled accelerometer has a high pass frequency output characteristic and is unable to measure a zero Hertz signal. Put another way, a DC coupled accelerometer is “zero Hertz capable,” while an AC coupled accelerometer is “non-zero Hertz capable.”

For instance, the AC coupled accelerometer may not measure data all the way to zero Hertz. This may also be referred to as not measuring data “all the way to DC”. The DC coupled accelerometer allows for measuring data to zero Hertz, and as a result, orientation information associated with the AC coupled accelerometer and the DC coupled accelerometer can be determined. In at least one embodiment, the DC coupled accelerometer is a DC coupled microelectromechanical system (MEMS) accelerometer. The DC coupled accelerometer can be calibrated by rolling a streamer housing the DC coupled accelerometer or through typical marine survey calibration techniques, as will be discussed further herein. While examples herein may include a single DC coupled accelerometer and a single AC coupled accelerometer, more than one of either or both can be used. At least one embodiment of the present disclosure allows for calibration of an AC coupled accelerometer using an already calibrated DC coupled accelerometer.

It is to be understood the present disclosure is not limited to particular devices or methods, which can, of course, vary. It is also to be understood that the terminology used herein is for the purpose of describing particular embodiments only and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected.

The figures herein follow a numbering convention in which the first digit or digits correspond to the drawing figure number and the remaining digits identify an element or component in the drawing. Similar elements or components between different figures can be identified by the use of similar digits. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

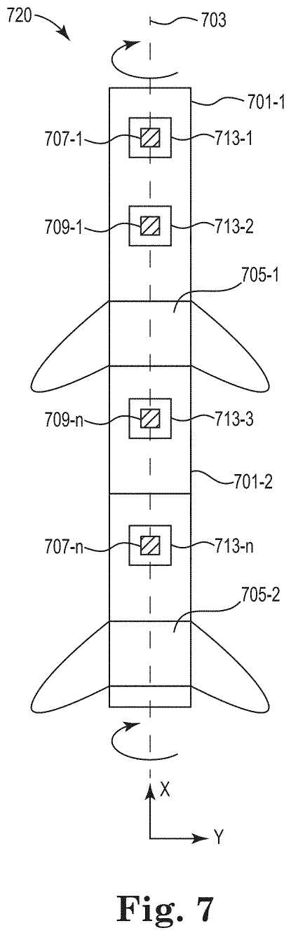

Multiple analogous elements within one figure may be referenced with a reference numeral followed by a hyphen and another numeral or a letter. For example, 707-1 may reference element 07-1 in FIGS. 7 and 707-n may reference element 07-n, which can be analogous to element 07-1. Such analogous elements may be generally referenced without the hyphen and extra numeral or letter. For example, elements 707-1 and 707-n may be generally referenced as 707.

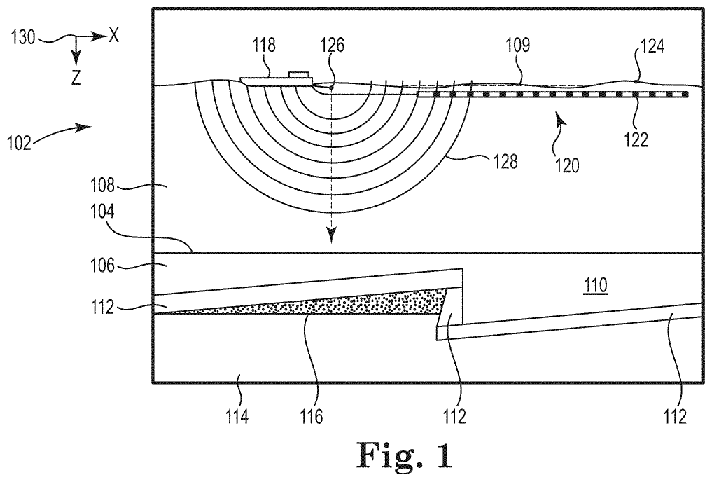

FIG. 1 illustrates an elevation or xz-plane 130 view of marine surveying in which signals are emitted by a source 126 for recording by receivers 122 for processing and analysis to help characterize the structures and distributions of features and materials underlying the surface of the earth. For example, such processing can include analogous processing of modeled and measured marine survey data. The processing can include determining application of AC coupled accelerometer characteristics, in at least one embodiment. The AC coupled accelerometer characteristics are determined separate from the processing in at least one embodiment. FIG. 1 shows a domain volume 102 of the earth's surface comprising a subsurface volume 106 of sediment and rock below the surface 104 of the earth that, in turn, underlies a fluid volume 108 of water having a sea surface 109 such as in an ocean, an inlet or bay, or a large freshwater lake. The domain volume 102 shown in FIG. 1 represents an example experimental domain for a class of marine surveys. FIG. 1 illustrates a first sediment layer 110, an uplifted rock layer 112, second, underlying rock layer 114, and hydrocarbon-saturated layer 116. One or more elements of the subsurface volume 106, such as the first sediment layer 110 and the uplifted rock layer 112, can be an overburden for the hydrocarbon-saturated layer 116. In some instances, the overburden can include salt.

FIG. 1 shows an example of a marine survey vessel 118 equipped to carry out marine surveys. The marine survey vessel 118 can tow one or more streamers 120 (shown as one streamer for ease of illustration) generally located below the sea surface 109. The streamers 120 can be long cables containing power and data-transmission lines (e.g., electrical, optical fiber, etc.) to which receivers can be coupled. In one type of marine survey, each receiver, such as the receiver 122 represented by the shaded disk in FIG. 1, comprises sensors including a particle motion sensor that detects particle motion in at least one orientation within the water, such as particle velocity or particle acceleration, and/or a hydrophone that detects variations in pressure. In one type of marine survey, each receiver, such as receiver 122, comprises an electromagnetic receiver that detects electromagnetic energy within the water. The streamers 120 and the marine survey vessel 118 can include sensing electronics and data-processing facilities that allow receiver readings to be correlated with absolute positions on the sea surface and absolute three-dimensional positions with respect to a three-dimensional coordinate system. In FIG. 1, the receivers along the streamers are shown to lie below the sea surface 109, with the receiver positions correlated with overlying surface positions, such as a surface position 124 correlated with the position of receiver 122. The marine survey vessel 118 can also tow one or more sources 126 that produce signals as the marine survey vessel 118 and streamers 120 move across the sea surface 109. Sources 126 and/or streamers 120 can also be towed by other vessels or can be otherwise disposed in fluid volume 108. For example, receivers can be located on ocean bottom cables or nodes fixed at or near the surface 104, and sources 126 can also be disposed in a nearly-fixed or fixed configuration. For the sake of efficiency, illustrations and descriptions herein show receivers located on streamers, but it should be understood that references to receivers located on a “streamer” or “cable” should be read to refer equally to receivers located on a towed streamer, an ocean bottom receiver cable, and/or an array of nodes. Data collected by receivers is referred to herein as measured marine survey data. Before the marine survey data is processed, it is referred to as raw measured marine survey data.

FIG. 1 shows an expanding, spherical signal, illustrated as semicircles of increasing radius centered at the source 126, representing a down-going wavefield 115, following a signal emitted by the source 126. The down-going wavefield 115 is, in effect, shown in a vertical plane cross section in FIG. 1. The outward and downward expanding down-going wavefield 128 can eventually reach the surface 104, at which point the outward and downward expanding down-going wavefield 115 can partially scatter, can partially reflect back toward the streamers 120, and can partially refract downward into the subsurface volume 106, becoming elastic signals within the subsurface volume 106.

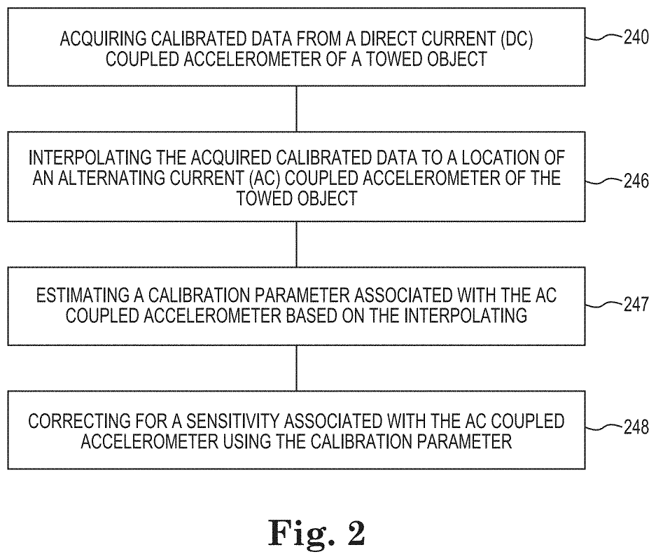

FIG. 2 illustrates an exemplary embodiment of a method flow diagram for AC coupled accelerometer calibration. In at least one embodiment, the method can be performed by a system or a controller, such as the machine illustrated in FIG. 6. In at least one embodiment, because the AC coupled accelerometers are not gimbal-mounted, an orientation of the AC coupled accelerometer relative to the DC coupled accelerometer may be desired because the AC coupled accelerometer and the DC coupled accelerometer may not remain at a constant orientation, but rather vary with movement of the towed object. For instance, a y-component and a z-component of the AC coupled accelerometers and the DC coupled accelerometers may be measured. The y- and z-components may be orthogonal to one another, but one or both of the components may not be pointed vertically based on an orientation of the towed object. The y and z-components, as well as x-components, are responses to gravitational acceleration in at least one embodiment.

As used herein, an orientation angle is an angle between a y-component of an AC coupled accelerometer and a y-component of a DC coupled accelerometer. If the AC coupled accelerometer and the DC coupled accelerometer are pointing in the same direction (e.g., the y-components are pointing in the same direction), the AC coupled accelerometer and the DC coupled accelerometer measure the same accelerations. Deviation in the orientation angle causes inconsistencies in acceleration measurements. Using data from a calibrated DC coupled accelerometer, corrections can be made for the deviation, and the AC coupled accelerometer can be calibrated, such that a sensitivity can be corrected for.

In at least one embodiment, the AC coupled accelerometers can exhibit a non-negligible temperature dependency, and as a result, characteristics of the AC coupled accelerometers may need to be determined in situ.

At 240, calibrated data is acquired from a direct current (DC) coupled accelerometer of a towed object. In at least one embodiment, a DC coupled accelerometer can include a low-grade DC coupled accelerometer and is a MEMS accelerometer. A low-grade DC coupled accelerometer can measure accelerations in a range from −5 to +5 G. The DC coupled accelerometer can be located with a threshold distance of the AC coupled accelerometer such that signal data, such as motion data, produced by both is correlated. For instance, in at least one embodiment, the DC coupled accelerometer and the AC coupled accelerometer are less than ten meters apart. The DC coupled accelerometer can be used as a low frequency calibration reference accelerometer and an orientation particle motion sensor in at least one embodiment. A DC particle motion sensor other than a DC coupled accelerometer may be used in at least one embodiment.

The calibrated data is data to which calibration settings have been applied. The calibrated data includes, for instance, data acquired during typical seismic data acquisition processes or data acquired during a towed object roll, for example a streamer roll. For instance, a DC coupled accelerometer can be calibrated before being deployed on a towed object and calibrated data from the DC coupled accelerometer can be acquired in a typical seismic acquisition process. As used herein, a typical seismic acquisition process includes acquiring data using sensors, receivers, and recording equipment, for instance as described with respect to FIG. 1. In at least one embodiment, a typical seismic acquisition process does not include streamer rolling. In at least one embodiment, the AC coupled accelerometer is an AC coupled piezoelectric particle motion sensor, and a high pass filter characteristic (also known as a sensitivity) of the AC coupled accelerometer is applied to determine a predicted response from the AC coupled accelerometer.

Alternatively, a DC coupled accelerometer can be calibrated while a streamer is rolled, and calibrated data information can be acquired during the roll. For instance, a streamer is rolled, and the DC coupled accelerometer housed on the streamer is calibrated to determine sensitivities of the DC coupled accelerometer in different axes of the DC coupled accelerometer. The calibration data can be used to determine an orientation of the streamer at a point and time. Orientation information received from the DC coupled accelerometer can be applied to an AC coupled accelerometer for use in calibration of the AC coupled accelerometer. For instance, the roll test orientation information from the DC coupled accelerometer can be used to predict what may be measured by the AC coupled accelerometer, as will be discussed further herein.

In at least one embodiment, the acquired calibrated data is filtered. Filtering, as used herein, removes unwanted components or features from a signal. For instance, when the calibrated data is acquired during a streamer roll, a low pass filter is applied to the acquired calibrated data to remove signal data outside a threshold of relevance to data associated with the streamer roll. When the calibrated data is acquired during a typical seismic acquisition process, a low pass filter is applied to the acquired calibrated data to remove DC coupled accelerometer data associated with a particle motion sensor noise floor. A low pass filter, as used herein, is a filter that passes signals with a frequency lower than a certain cutoff frequency and attenuates signals with frequencies higher than the cutoff frequency. A noise floor, such as a particle motion sensor noise floor, is the measure of the signal created from the sum of all the noise sources and unwanted signals within a measurement system, where noise is defined as any signal other than the one being monitored. As noted, in at least one embodiment, the DC coupled accelerometer is a MEMS accelerometer. Above a particular frequency, an output from the MEMS accelerometer may be associated only with internal noise from sensors and/or readout electronics of the MEMS accelerometer. In such an example, above for instance, 10 Hertz, a sensor output may be noise that has no correlation to the environment in which the sensor is mounted. To suppress the noise, the acquired calibrated data is low pass filtered.

At 246, the acquired calibrated data is interpolated to a location of an AC coupled accelerometer of the towed object. As used herein, interpolation can include constructing new data points within the range of a discrete set of known data points. For instance, when the calibrated data is acquired during a streamer roll, as noted above, roll test orientation information from the DC coupled accelerometer is used to predict what to measure with the AC coupled accelerometer. In at least one embodiment, the DC coupled accelerometer and the AC coupled accelerometer may not be in a same location on the towed object, so orientation angle information is interpolated to a location of the AC coupled accelerometer. As used herein, orientation angle information can describe a relative deviation from an orientation angle between the AC coupled accelerometer and the DC coupled accelerometer.

Based on the interpolation, a determination can be made as to what kind of response can be expected based on the orientation of a y-component and a z-component of the AC coupled accelerometer. In at least one embodiment, the AC coupled accelerometer is an AC coupled piezoelectric particle motion sensor, and a high pass filter characteristic of the AC coupled accelerometer is applied to determine a predicted response from the AC coupled accelerometer. In at least one embodiment, the determination of the predicted response is an iterative optimization process, as will be discussed further herein.

In at least one embodiment in which the data is acquired during a typical seismic data acquisition, an orientation angle may not be interpolated because streamer roll information is unavailable, so the acquired calibrated data, including components of the DC coupled accelerometer, is interpolated to a location of the AC coupled accelerometer. For instance, the components can include a measured acceleration of y- and z-components of the DC coupled accelerometer.

At 247, a calibration parameter associated with the AC coupled accelerometer is estimated based on the interpolating. The calibration parameter, as used herein, is a parameter used to calibrate the AC coupled accelerometer. In at least one embodiment, the estimation is additionally based on the filtering. In at least one embodiment, estimating the calibration parameter includes estimating an orientation angle deviation between the AC coupled accelerometer and the DC coupled accelerometer, a resistor-capacitor (RC) response of the AC coupled accelerometer, and a different sensitivity of the AC coupled accelerometer. The orientation angle deviation, as used herein, is a deviation in an orientation angle between a y-component of the AC coupled accelerometer and a y-component of the DC coupled accelerometer. As used herein, a different sensitivity of the AC coupled accelerometer is a sensitivity associated with a y-component of the AC coupled accelerometer. The different sensitivity can be scalar, and it can be what is calibrated during AC coupled accelerometer calibration. The different sensitivity is how sensitive the AC coupled accelerometer is. In at least one embodiment, the difference sensitivity is a calibrated sensitivity that is different than the initial sensitivity. The RC response is an output by the AC coupled accelerometer responsive to an RC input.

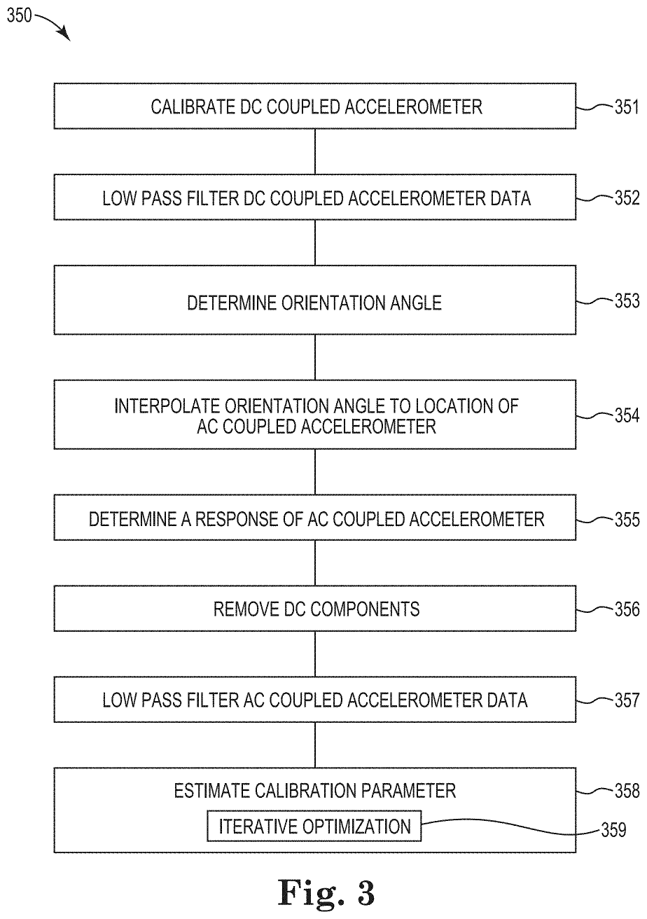

The RC response of the AC coupled accelerometer and the different sensitivity of the AC coupled accelerometer can be estimated for each of the x-, y-, and z-components of the AC coupled accelerometer. In at least one embodiment, the orientation angle deviation is estimated for the x- and the z-components. In at least one embodiment, an iterative optimization process is performed to estimate the calibration parameters, as will be discussed further herein with respect to FIG. 3 and algorithms (1), (2), and (3).

If it is determined that a predicted response does not match actual AC coupled accelerometer data, a calibration can be recalculated by searching for an optimum RC response or sensitivity that results in a minimum difference between the actual measured responses and the predicted responses. In at least one embodiment, the AC coupled accelerometer is calibrated in response to water temperature changes.

At 248, a sensitivity associated with the AC coupled accelerometer can be corrected for using the calibration parameter. For instance, the sensitivity can include a ratio of the AC coupled accelerometer's electrical output to mechanical input. Put another way, sensitivity is the output voltage produced by a certain force measured in G's. Correction, in at least one embodiment, includes modifying data such that the DC coupled accelerometer and the AC coupled accelerometer read the same accelerations. In at least one embodiment, correction includes adjusting the AC coupled accelerometer's sensitivity to measure acceleration as desired. Correction, in at least on embodiment includes causing a towed object access to rotate so the AC coupled accelerometer and the DC coupled accelerometer point in the same direction. In at least one embodiment, correcting for the sensitivity includes correcting for an RC response.

FIG. 3 illustrates an exemplary embodiment of a method flow diagram 350 for AC coupled accelerometer calibration. In at least one embodiment, the method can be performed by a system or a controller, such as the system illustrated in FIG. 6. At 351, a DC coupled accelerometer is calibrated. In at least one embodiment, the DC coupled accelerometer is calibrated during a towed object roll, for instance a streamer roll. The DC coupled accelerometer is located on the towed object, and in at least one embodiment, the towed object is a streamer. The streamer is rolled, and data is measured by the DC coupled accelerometer as the streamer is rolled. For instance, a roll test of the streamer is performed, and measurements of a response to gravitational acceleration by the DC coupled accelerometer are measured. Using this measured data, a calibration parameter is computed and used to calibrate the DC coupled accelerometer. In at least one embodiment, the DC coupled accelerometer is a low-grade DC coupled MEMS accelerometer.

At 352, the DC coupled accelerometer data is low pass filtered. The data from the calibrated DC coupled accelerometer is low pass filtered to remove content below a relevant threshold with respect to information related to the streamer roll. In at least one embodiment, the data is filtered to remove motions and vibrations of the streamer unrelated to gravitational accelerations. At particular frequencies, data from the DC coupled accelerometer may be dominated by a response to the gravitational acceleration, so using a low pass filter of approximately one to two Hertz can avoid the inclusion of the motions and vibrations of the streamer and remove content below a relevant threshold. As used herein, “approximately” includes a value within a particular margin, range, and/or threshold.

At 353, an orientation angle is determined. The orientation angle is determined using the DC coupled accelerometer low pass filtered data and is based on orthogonal components of the DC coupled accelerometer. In at least one embodiment, the orthogonal components can be a vertical reference y-component and a horizontal reference z-component. While referred to as vertical and horizontal, the components' directions can vary based on a position of the towed object housing the DC coupled accelerometer. If one component is pointing vertical, it can measure 1 gravitation acceleration unit, while the orthogonal component can measure 0 gravitational acceleration units. In at least one embodiment, an orientation angle around a horizontal x-axis is determined as arctan (z/y), wherein z and y are the z-component and the y-component, respectively.

At 354, the orientation angle is interpolated to a location of the AC coupled accelerometer. In at least one embodiment, the interpolation is performed to compensate for the AC coupled accelerometer being in a different location on the towed object as compared to the DC coupled accelerometer.

At 355, a response of the gravitational acceleration of the AC coupled accelerometer is determined. At 356, a DC component of the response of the gravitational acceleration is removed, and in at least one embodiment a DC component is removed because the AC coupled accelerometer does not record to zero Hertz. The DC component can be removed by subtraction of a mean value of the low pass filtered data acquired from the calibrated DC coupled accelerometer or by high pass filtering of the low pass filtered data acquired from the calibrated DC coupled accelerometer. High pass filtering, as used herein, passes signals with a frequency higher than a certain cutoff frequency and attenuates signals with frequencies lower than the cutoff frequency. High pass filtering can be used, for instance, if data is noisy or unreliable in the AC coupled accelerometer and can pass signals with a frequency higher than a certain cutoff frequency and attenuate signals with frequencies lower than the cutoff frequency.

At 357, AC coupled accelerometer data is low pass filtered. The low pass filter used to filter the AC coupled accelerometer data can be the same or similar to the low pass filter used to filter the DC coupled accelerometer data. In at least one embodiment, the same or similar low pass filters can allow for matching of AC coupled accelerometer data and DC coupled accelerometer data. For example, DC data introduced, for instance by electronics, can be filtered from data associated with the AC coupled accelerometer because an AC coupled accelerometer cannot detect DC data.

A calibration parameter is estimated at 358 for the AC coupled accelerometer. To estimate a calibration parameter, low pass filtered or interpolated data acquired from the calibrated DC coupled accelerometer and the low pass filtered AC coupled accelerometer data is fed into an optimization algorithm that solves for a sensitivity, an RC response, and an orientation angle of the AC coupled accelerometer relative to the DC coupled accelerometer. If DC coupled accelerometers are in different positions than AC coupled accelerometers, interpolated data is used for estimation of calibration parameters. Calibration parameters include, for instance, sensitivities, RC responses, and orientation angles of individual AC coupled accelerometer vectors relative to individual DC coupled accelerometer vectors.

The optimization process, for instance at 359, in at least one embodiment, is an iterative optimization process such as a Nelder-Mead simplex direct search method. Such an iterative process can include iteratively minimizing a goal function as illustrated in algorithms (1), (2), and (3) below.

For instance, in at least one embodiment, when standard vector rotations are:

y′=y cos θ−z sin θ and

z′=y sin θ−z cos θ,

the optimization includes a minimization of the following goal function:

|A_{y,AC accel}−(A_{y,DC accel} cos θ_{y}−A_{z,DC accel} sin θ_{y})RC(f_{o,y})S_{Ay,AC accel}|² (1)

|A_{z,AC accel}−(A_{y,DC accel} sin θ_{z}−A_{z,DC accel} cos θ_{z})RC(f_{o,z})S_{Az,AC accel}|² (2)

The relationships between the AC coupled accelerometer measurements can be:

A_{y,AC accel}=(A_{y,DC accel} cos θ_{y}−A_{z,DC accel} sin θ_{y})RC(f_{o,y})S_{Ay,AC accel} and

A_{z,AC accel}=(A_{y,DC accel} sin θ_{z}−A_{z,DC accel} cos θ_{z})RC(f_{o,z})S_{Az,AC accel}

In at least one embodiment in which an AC coupled accelerometer is parallel with a towed object axis (such as a streamer axis), the goal function for the optimization can be:

|A_{x,AC accel}−RC(f_{o,x})S_{A}_{ₓ}_{,AC sensor}A_{x,DC accel}|² (3)

where A_{x,y,z[ ]} is an acceleration output from either the AC coupled accelerometer or the DC coupled accelerometer. In at least one embodiment, θ_{y}_{ₙ}_{z} is a relative deviation in orientation angle between the DC coupled accelerometer and the AC coupled accelerometer, RC(f_{o,x,y,z}) is an RC response of the AC coupled accelerometer, and S_{x,y,z[ ]} is a sensitivity of respective AC coupled accelerometers.

By feeding the optimization algorithm a combination of data acquired from the AC coupled accelerometer and data acquired while rolling a streamer on its longitudinal axis, a stable output from the optimization algorithm can be achieved.

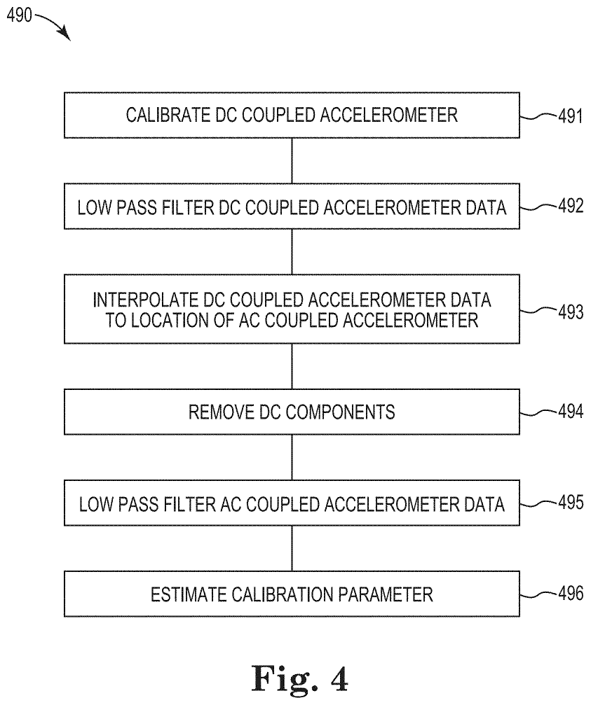

FIG. 4 illustrates an exemplary embodiment of a method flow diagram 490 for AC coupled accelerometer calibration. In at least one embodiment, the method can be performed by a system or a controller, such as the system illustrated in FIG. 6. At 491, a DC coupled accelerometer is calibrated. In at least one embodiment, the DC coupled accelerometer is calibrated during manufacturing, such that the DC coupled accelerometer is not calibrated during data acquisition. For instance, a DC coupled accelerometer can be calibrated before being deployed on a towed object and calibrated data from the DC coupled accelerometer can be acquired in a typical seismic acquisition process. The calibrated data is used to calibrate an AC coupled accelerometer located on the same towed object, in at least one embodiment.

At 492, data from the DC coupled accelerometer is low pass filtered. In at least one embodiment, the filtering can be performed using a higher frequency low pass filter as compared to DC coupled accelerometer data collected during a streamer roll because a larger bandwidth of data may be desired. For instance, the filter may be set to filter at approximately ten to fifteen Hertz as compared to approximately one to two Hertz. In at least one embodiment, low pass filtering the DC coupled accelerometer data can remove DC coupled accelerometer data associated with a particle motion sensor noise floor rather than a specific signal. For instance, this can result in a signal with a greater bandwidth than in a method associated with FIG. 3 (e.g., at 352).

The low pass filtered DC coupled accelerometer data is interpolated to a location of an AC coupled accelerometer at 493. For instance, y- and z-components of the DC coupled accelerometer can be interpolated to the location of the AC coupled accelerometer.

At 494, a DC component of the DC coupled accelerometer is removed to render a signal similar to a signal associated with the AC coupled accelerometer because the AC coupled accelerometer cannot include DC data. At 495, the AC coupled motion sensor data can be low pass filtered. For instance, the AC coupled accelerometer data is low pass filtered using a same or similar low pass filter as used for the DC coupled accelerometer data to render similar data sets.

Calibration parameters for the AC coupled accelerometer is estimated at 496 based on algorithms (1), (2), and (3), and using an iterative optimization process as described above with respect to elements 358 and 359 of FIG. 3.

In at least one embodiment, a method associated with FIG. 4 as described herein can be used if an AC coupled accelerometer horizontal inline component is to be calibrated. In at least one embodiment a method associated with FIG. 4 as described herein provides more accurate estimations of an orientation angle and a calibration parameter as compared to approaches using a narrower bandwidth during low pass filtering.

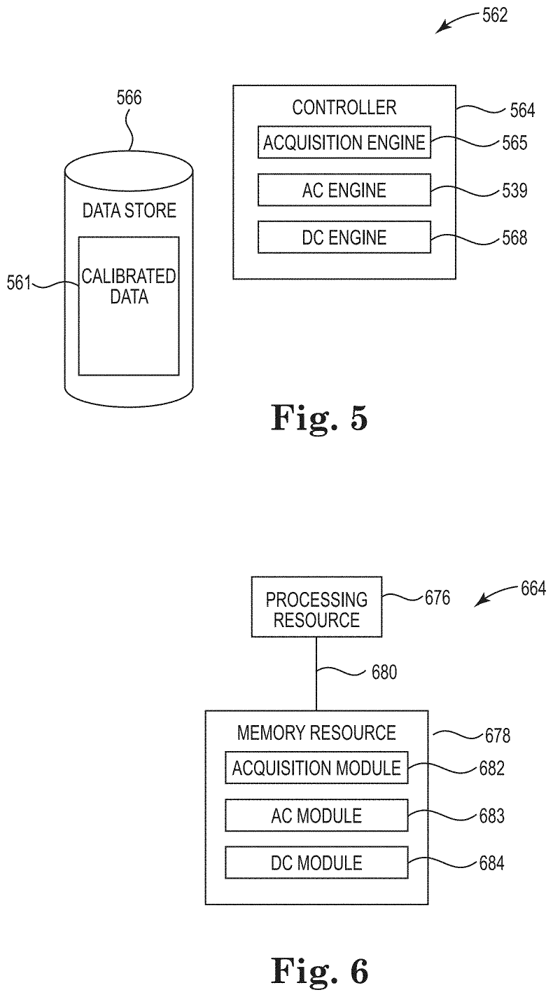

FIG. 5 illustrates an exemplary embodiment of a diagram of a system 562 for AC coupled accelerometer calibration. The system 562 can include a data store 566, and a controller 564. The controller 564 can include engines, such as an acquisition engine 565, AC engine 539, and DC engine 568. The controller 564 and engines can be in communication with the data store 566 via a communication link. The system 562 can include additional or fewer engines than illustrated to perform the various functions described herein. The system can represent program instructions and/or hardware of a machine such as the machine 664 referenced in FIG. 6, etc. As used herein, an “engine” can include program instructions and/or hardware, but at least includes hardware. Hardware is a physical component of a machine that enables it to perform a function. Examples of hardware can include a processing resource, a memory resource, a logic gate, etc.

The engines can include a combination of hardware and program instructions that is configured to perform functions described herein. The program instructions, such as software, firmware, etc., can be stored in a memory resource such as a machine-readable medium, etc., as well as hard-wired program such as logic. Hard-wired program instructions can be considered as both program instructions and hardware.

The acquisition engine 565 can include a combination of hardware and program instructions that is configured to acquire data from a calibrated DC coupled accelerometer of a towed object. The calibrated data 561 can be stored in the data store 566. The DC engine 568 can include a combination of hardware and program instructions that is configured to low pass filter the acquired data. For instance, the instructions can be executable to remove acquired data associated with a particle motion sensor noise floor.

The AC engine 539 can include a combination of hardware and program instructions that is configured to interpolate the acquired data to a location of an AC coupled accelerometer of the towed object, and the DC engine 568 is configured to remove a DC component from the interpolated data. The AC engine 539 is configured to low pass filter the interpolated data with the DC component removed, and in at least one embodiment, instructions are executable to low pass filter the acquired data and low pass filter the interpolated data with a filter that passes signals between approximately ten and fifteen Hertz.

The AC engine 539 is configured to estimate a calibration parameter associated with the AC coupled accelerometer using the low pass filtered data acquired from the calibrated DC coupled accelerometer and the low pass filtered interpolated data and correct for a sensitivity of the AC coupled accelerometer using the estimated calibration parameter.

The controller 564 can include a combination of hardware and program instructions that is configured to perform a plurality of functions for AC coupled accelerometer calibration as described herein, for instance with respect to FIGS. 6 and 7.

FIG. 6 illustrates an exemplary embodiment of a diagram of a machine 664 for AC coupled accelerometer calibration. The machine 664 can utilize software, hardware, firmware, and/or logic to perform functions. The machine 664 can be a combination of hardware and program instructions configured to perform functions. The machine is also generally referred to herein as a system and can include a controller (not illustrated in FIG. 6) analogous to the controller 564 illustrated in FIG. 5. The hardware, for example, can include processing resources 676 and memory resources 678, such as a machine-readable medium or other non-transitory memory resources 678. In at least one embodiment, the controller can include the memory resources 678 and the processing resources 676 and can be communicatively coupled to a streamer housing an AC coupled accelerometer and a DC coupled accelerometer. As used herein, “communicatively coupled” can include coupled via various wired and/or wireless connections between devices such that data can be transferred in various directions between the devices. The coupling need not be a direct connection, and in some examples, can be an indirect connection. The streamer can be part of the system.

The memory resources 678 can be internal and/or external to the machine 664. For example, the machine 664 can include internal memory resources and have access to external memory resources. The program instructions, such as machine-readable instructions, can include instructions stored on the machine-readable medium to implement a particular function, for example, an action such as calibrating a magnetometer based on roll data or turn data. The set of machine-readable instructions can be executable by one or more of the processing resources 676. The memory resources 678 can be coupled to the machine 664 in a wired and/or wireless manner. For example, the memory resources 678 can be an internal memory, a portable memory, a portable disk, or a memory associated with another resource, for example, enabling machine-readable instructions to be transferred or executed across a network such as the Internet. As used herein, a “module” can include program instructions and/or hardware, but at least includes program instructions.

Memory resources 678 can be non-transitory and can include volatile and/or non-volatile memory. Volatile memory can include memory that depends upon power to store data, such as various types of dynamic random-access memory among others. Non-volatile memory can include memory that does not depend upon power to store data. Examples of non-volatile memory can include solid state media such as flash memory, electrically erasable programmable read-only memory, phase change random access memory, magnetic memory, optical memory, and a solid-state drive, etc., as well as other types of non-transitory machine-readable media.

The processing resources 676 can be coupled to the memory resources 678 via a communication path 680. The communication path 680 can be local or remote to the machine 664. Examples of a local communication path 680 can include an electronic bus internal to a machine, where the memory resources 678 are in communication with the processing resources 676 via the electronic bus. Examples of such electronic buses can include Industry Standard Architecture, Peripheral Component Interconnect, Advanced Technology Attachment, Small Computer System Interface, Universal Serial Bus, among other types of electronic buses and variants thereof. The communication path 680 can be such that the memory resources 678 are remote from the processing resources 676, such as in a network connection between the memory resources 678 and the processing resources 676. That is, the communication path 680 can be a network connection. Examples of such a network connection can include a local area network, wide area network, personal area network, and the Internet, among others.

As shown in FIG. 6, the machine-readable instructions stored in the memory resources 678 can be segmented into a plurality of modules 682, 683, and 684 that when executed by the processing resources 676 can perform functions. As used herein a module includes a set of instructions included to perform a particular task or action. The modules 682, 683, and 684 can be sub-modules of other modules. For example, the AC module 683 can be a sub-module of the DC module 684. In at least one embodiment modules 682, 683, and 684 can be contained within a single module. Furthermore, the modules 682, 683, and 684 can comprise individual modules separate and distinct from one another. Examples are not limited to the specific modules 682, 683, and 684 illustrated in FIG. 6. Although not specifically illustrated, the memory resources 678 can store (at least temporarily) calibrated roll data for operation thereon by the acquisition module 682, AC module 683, and DC module 684.

Each of the modules 682, 683, and 684 can include program instructions or a combination of hardware and program instructions that, when executed by a processing resource 676, can function as a corresponding engine as described with respect to FIG. 5. For example, the acquisition module 682 can include program instructions or a combination of hardware and program instructions that, when executed by a processing resource 676, can function as the acquisition engine 565. The AC module 683 can include program instructions or a combination of hardware and program instructions that, when executed by a processing resource 676, can function as the AC engine 539. The DC module 684 can include program instructions or a combination of hardware and program instructions that, when executed by a processing resource 676, can function as the DC engine 568.

The machine 664, through executable instructions and/or hardwired circuitry, can be configured to cause a portion of a towed object to roll. For instance, the machine 664 can be configured to cause a portion of a streamer to roll. The machine 664 can be configured to acquire data from a DC coupled accelerometer calibrated during the roll, and the machine 664 can be configured to low pass filter data acquired from the calibrated DC coupled accelerometer. The machine 664 can be configured to determine an orientation angle deviation between the calibrated DC coupled accelerometer and an AC coupled accelerometer using the low pass filtered data acquired from the calibrated DC coupled accelerometer. In at least one embodiment, the machine 664 can be configured to interpolate the orientation angle deviation to a location of an AC coupled accelerometer and determine a response of the gravitational acceleration at the location of the AC coupled accelerometer based on the interpolated orientation angle deviation. The response can include vertical and horizontal response data.

The machine 664 can be configured to remove DC components of the response data and low pass filter the response data associated with the AC coupled accelerometer. DC components include data associated with the DC coupled accelerometer in the response data. The response data includes an output from the AC coupled accelerometer responsive to an input. The DC components can be removed because they may be associated with an unusable high frequency. The machine 664 can be configured to remove the DC components by subtraction of a mean value of the low pass filtered data acquired from the calibrated DC coupled accelerometer or by high pass filtering the low pass filtered data acquired from the calibrated DC coupled accelerometer, among other removal approaches. The controller 664 can be configured to low pass filter the response data associated with the AC coupled accelerometer. In at least one embodiment, the controller 664 can be configured to low pass filter data acquired from the calibrated DC coupled accelerometer and low pass filter the response data associated with the AC coupled accelerometer with a filter that passes signals between approximately one and two Hertz.

In at least one embodiment, the machine 664 can be configured to estimate a plurality of calibration parameters associated with the AC coupled accelerometer using the low pass filtered data acquired from the calibrated DC coupled accelerometer and the low pass filtered response data and correct for a sensitivity associated with the AC coupled accelerometer. using the estimated calibration parameter.

In accordance with at least one embodiment of the present disclosure, a geophysical data product or seismic image may be produced. Geophysical data may be obtained and stored on a non-transitory, tangible computer-readable medium. The geophysical data product may be produced by processing the geophysical data offshore or onshore either within the United States or in another country. If the geophysical data product is produced offshore or in another country, it may be imported onshore to a facility in the United States. In some instances, once onshore in the United States, geophysical analysis may be performed on the geophysical data product. In some instances, geophysical analysis may be performed on the geophysical data product offshore. In at least one embodiment, the seismic image can be recorded on one or more non-transitory machine-readable media, thereby creating the geophysical data product.

FIG. 7 illustrates a bottom view of various sections 701-1, 701-2 of a towed object 720. A longitudinal axis 703 of the towed object 720 is illustrated as being aligned with a direction along the x-axis in which the towed object is being towed. A towed object 720 can be any object towed by a marine vessel such as a marine survey vessel. Examples of towed objects 720 include a source, a receiver, or a streamer. In the embodiment illustrated in FIG. 7, the towed object 720 is depicted as a portion of a streamer including a first streamer section 701-1 and a second streamer section 701-2. A first depth control device 705-1 is coupled to the first streamer section 701-1 and a second depth control device 705-2 is coupled to the second streamer section 701-2. As illustrated, the first depth control device 705-1 may be said to be coupled to both the first streamer section 701-1 and the second streamer section 701-2, however embodiments are not so limited as there may be other portions of the towed object 720 between the first depth control device 705-1 and the second depth control device 705-2.

The first streamer section 701-1 and the second streamer section 701-2 are illustrated with spacers 713-1, 713-2, 713-3, . . . 713-n. Spacers 713 can be positioned along the length of towed object 720 and can support the towed object 720. While four spacers (two on each streamer section) are illustrated herein, more or fewer spacers may be located on a towed object 720. The spacers 713 can house AC coupled accelerometers 707-1, . . . , 707-n and DC coupled accelerometers 709-1, 709-n. For example, spacers 713 can include pockets for insertion of AC coupled accelerometers 707 or DC coupled accelerometers 709.

The AC coupled accelerometers 707 can be actively powered devices, passive devices such that they are not actively powered, or a combination thereof. The DC coupled accelerometers 709 can be actively powered devices and can be powered by internal components of the towed object. In at least one embodiment, the AC coupled accelerometers 707 are passive devices to reduce power consumption of a marine surveying system.

In at least one embodiment, a controller can cause the towed object 720 to be rolled using the depth control devices 705. The towed object 720 can be coupled to the controller (not specifically illustrated in FIG. 7). The controller can be onboard a marine survey vessel that tows the towed object 720. The coupling between the controller and the towed object 720 for communication purposes can be wired or wireless. For example, electrical or optical cabling can run along or within the towed object 730 and be coupled to the DC coupled accelerometers 709, the AC coupled accelerometers 707, and/or the depth control devices 705, as well as the controller. As another example, the towed object 720, the DC coupled accelerometers 709, the AC coupled accelerometers 707, and/or the depth control devices 705 can be in wireless communication with the controller. The controller can control operation of the depth control devices, receive data from the DC coupled accelerometers 709 and the AC coupled accelerometers 707-1, among other functions.

Wings of the depth control devices 705 can be adjusted to cause the towed object 720 to roll. In at least one embodiment, the entire towed object 720 or multiple sections of the towed object 720 can be rolled along the longitudinal axis 703 using a plurality of the depth control devices 705.

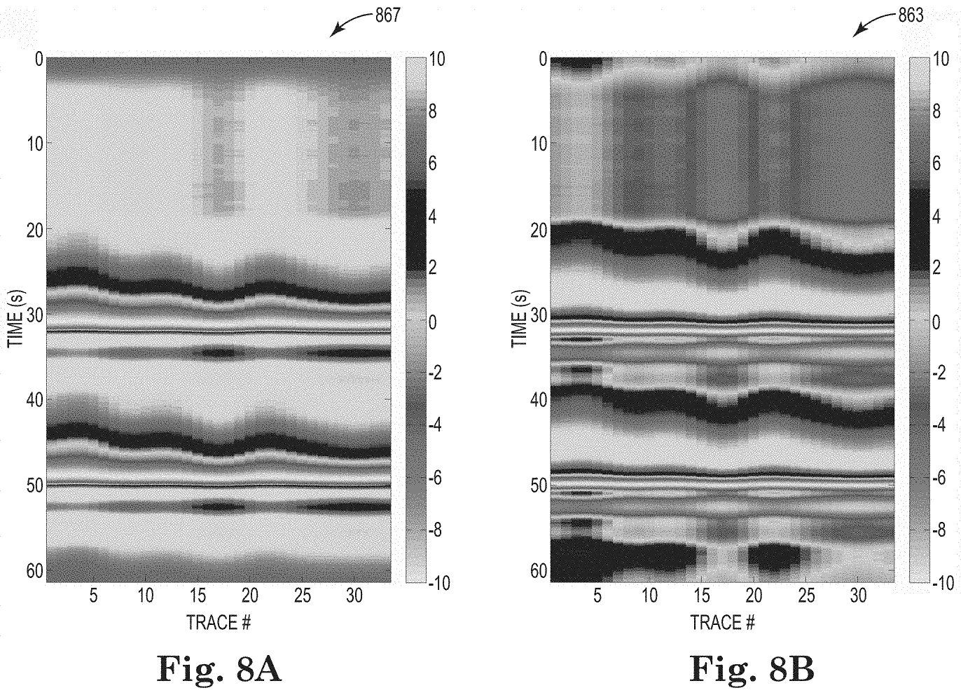

FIGS. 8A and 8B illustrate diagrams 867 and 863 of results of an example acceleration data from DC coupled accelerometers. For instance, FIG. 8A illustrates sixty seconds of interpolated data resulting from an interpolation of DC coupled accelerometer y-component reference data. FIG. 8B illustrates sixty seconds of interpolated data resulting from an interpolation of DC coupled accelerometer z-component reference data. In both diagrams 867 and 863, time is illustrated on the left vertical axis in seconds, a trace number, also known as a location or channel number of DC coupled accelerometers on a towed object, is illustrated on the horizontal axis in meters or channel number. Acceleration in meters per second squared is illustrated on the right vertical axes of diagrams 867 and 863 and is represented by changes in shading in diagrams 867 and 863.

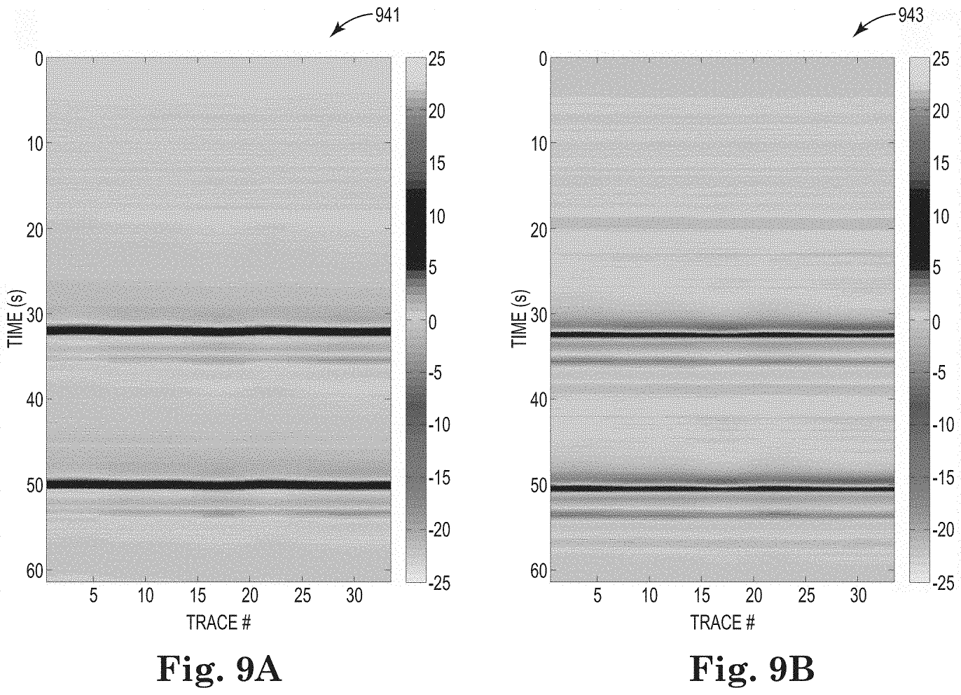

FIGS. 9A and 9B illustrate diagrams 941 and 943 of results of an example physical experiment for AC coupled accelerometer calibration. Diagrams 941 and 943 illustrate predicted AC coupled accelerometer traces from interpolated DC coupled accelerometers. In at least one embodiment, the traces are predicted piezoelectric AC coupled accelerometer traces from DC coupled accelerometers. In at least one embodiment, DC components have been removed, and an RC response has been applied to simulate what to expect to record by the AC coupled accelerometers. Diagram 941 illustrates a trace associated with y-component responses, while diagram 943 illustrates a trace associated with z-component responses. In both diagrams 941 and 943, time is illustrated on the left vertical axis in seconds, a trace number, also known as a location of DC coupled accelerometers on a towed object, is illustrated on the horizontal axis in meters or channel number and positioning as above. Acceleration in millimeters per second squared is illustrated on the right vertical axes of diagrams 941 and 943 and is represented by changes in shading in diagrams 941 and 943.

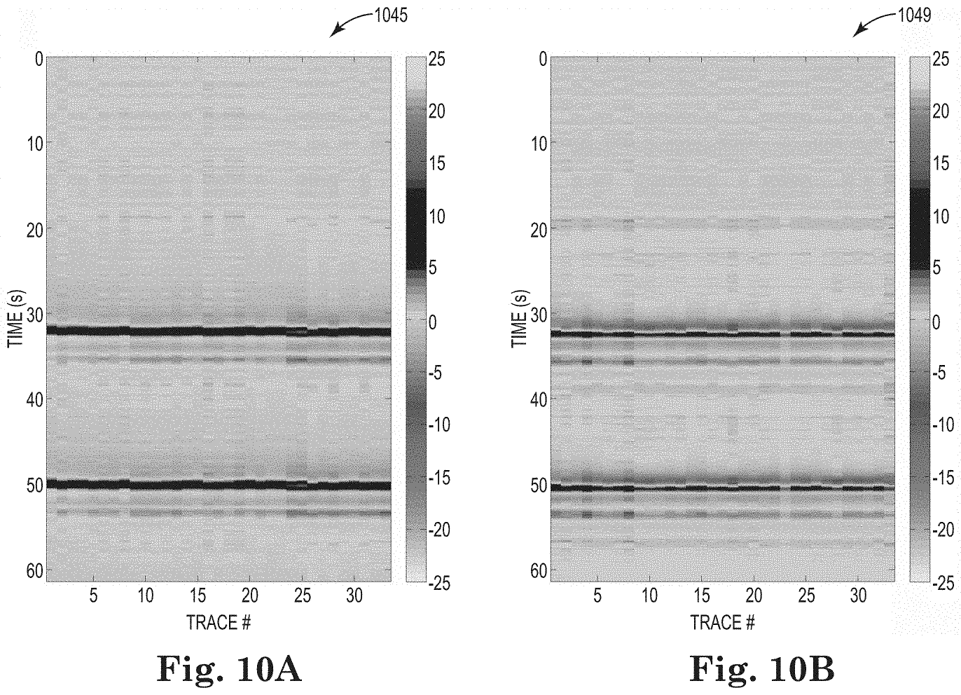

FIGS. 10A and 10B illustrate diagrams 1045 and 1049 of results of an example physical experiment for AC coupled accelerometer calibration. Diagrams 1045 and 1049 illustrate traces of actual measurements by AC coupled accelerometers. In at least one embodiment, the traces are piezoelectric AC coupled accelerometer traces. Diagram 1045 illustrates a trace associated with y-component responses, while diagram 1049 illustrates a trace associated with z-component responses. In both diagrams 1045 and 1049, time is illustrated on the left vertical axis in seconds, a trace number, also known as a location of DC coupled accelerometers on a towed object, is illustrated on the horizontal axis in meters. Acceleration in millimeters per second squared is illustrated on the right vertical axes of diagrams 1045 and 1049 and is represented by changes in shading in diagrams 1045 and 1049. A comparison of FIGS. 10A and 10B to FIGS. 9A and 9B, respectively, illustrates that predicted AC coupled accelerometer behavior (FIGS. 9A and 9B) can be very similar to actual AC coupled accelerometer behavior when sensitivities and RC responses are considered, for instance. In at least one embodiment, variations between FIGS. 9A and 10A and FIGS. 9B and 10B may be a result of a calibration parameter for an AC coupled accelerometer having an incorrect calibration.

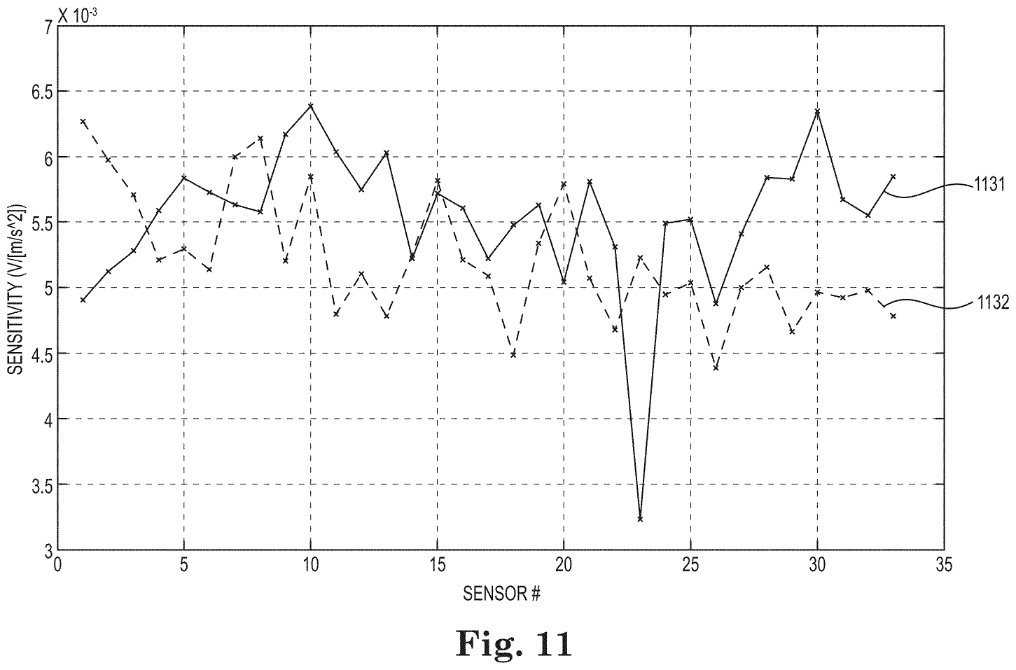

FIG. 11 illustrates a diagram of results of an example physical experiment for AC coupled accelerometer calibration. For example, when determining an AC coupled accelerometer calibration factors, it may be desired to find a minimum difference between measured and predicted results. In at least one embodiment, vertical sensitivities 1131 and horizontal sensitivities 1132 can be considered. In FIG. 11, sensitivity is illustrated on the y-axis in volts per meter per second squared, and a sensor number is illustrated on the x-axis. The sensor number can be a location in meters on a towed object of an AC coupled accelerometer.

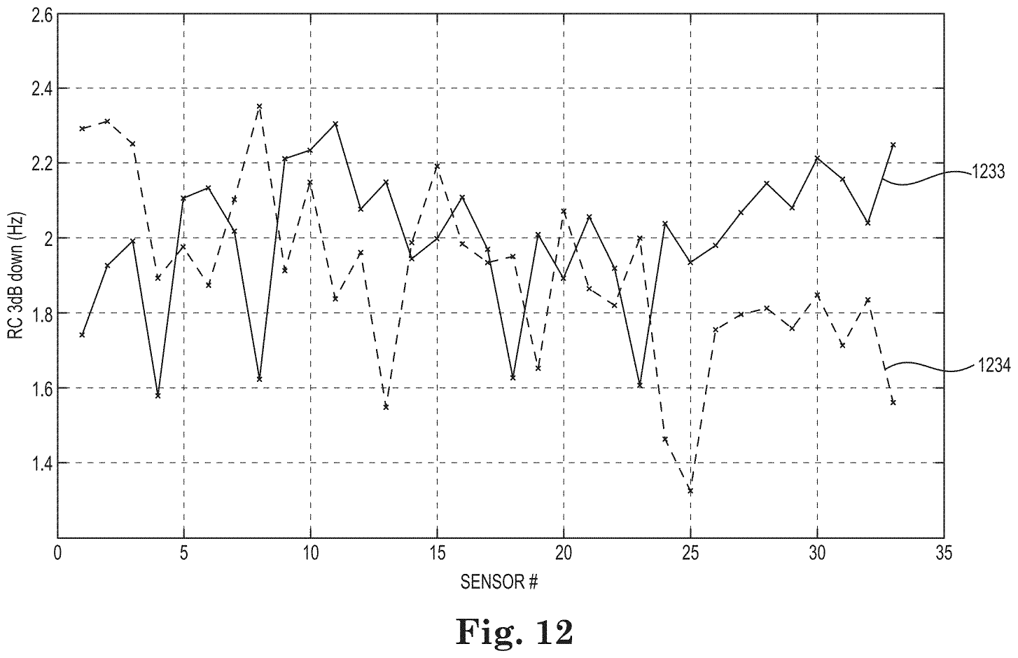

FIG. 12 illustrates a diagram of results of an example physical experiment for AC coupled accelerometer calibration. FIG. 12 illustrates the 3 dB down point of an RC response. The y-axis illustrates the 3 dB down point frequency, while a sensor number is illustrated on the x-axis. The sensor number can be a location in meters on a towed object of an AC coupled accelerometer. In at least one embodiment, frequencies of the y components 1233 and for the z components 1234 can be considered.

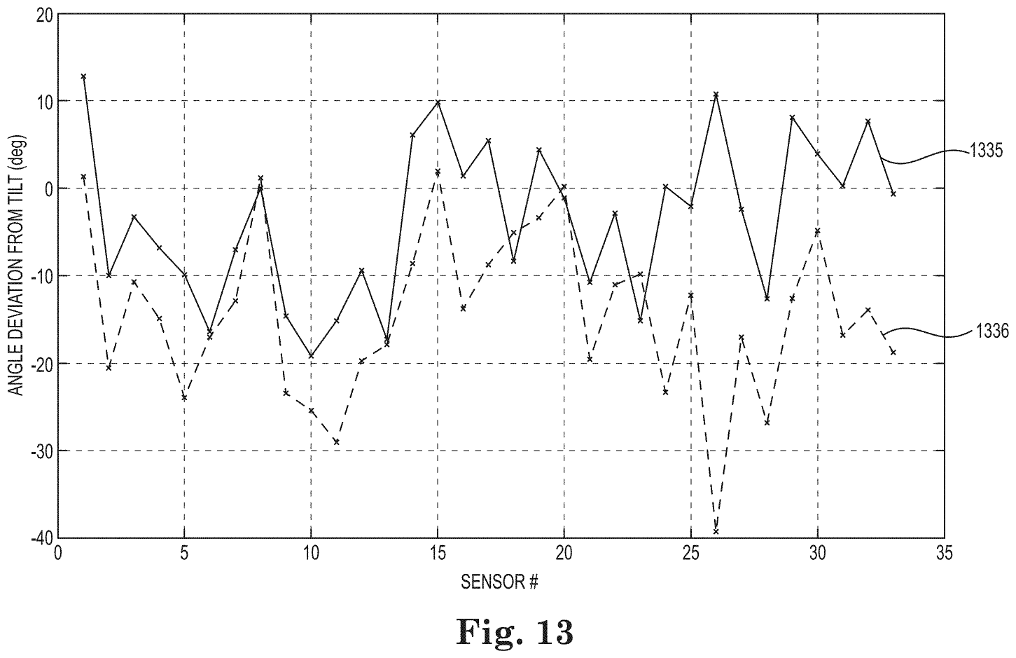

FIG. 13 illustrates a diagram of results of an example physical experiment for AC coupled accelerometer calibration. FIG. 13 illustrates a deviation in an orientation of an axis of an AC coupled accelerometer. For instance, when performing optimization of the goal functions, there can be an angle present between an AC coupled accelerometer and a DC coupled accelerometer because a y-axis of the DC coupled accelerometer may not be exactly oriented with a y-axis of the AC coupled accelerometer. In such an example, it can be determined whether there is a deviation in an orientation angle determined as part of the calibration process. FIG. 13 illustrates angle deviation from a DC coupled accelerometer in degrees (y-axis) by sensor number (x-axis). The sensor number can be a location in meters on a towed object of an AC coupled accelerometer. Deviation of a y-axis is illustrated at 1335, and deviation of a z-axis is illustrated at 1336.

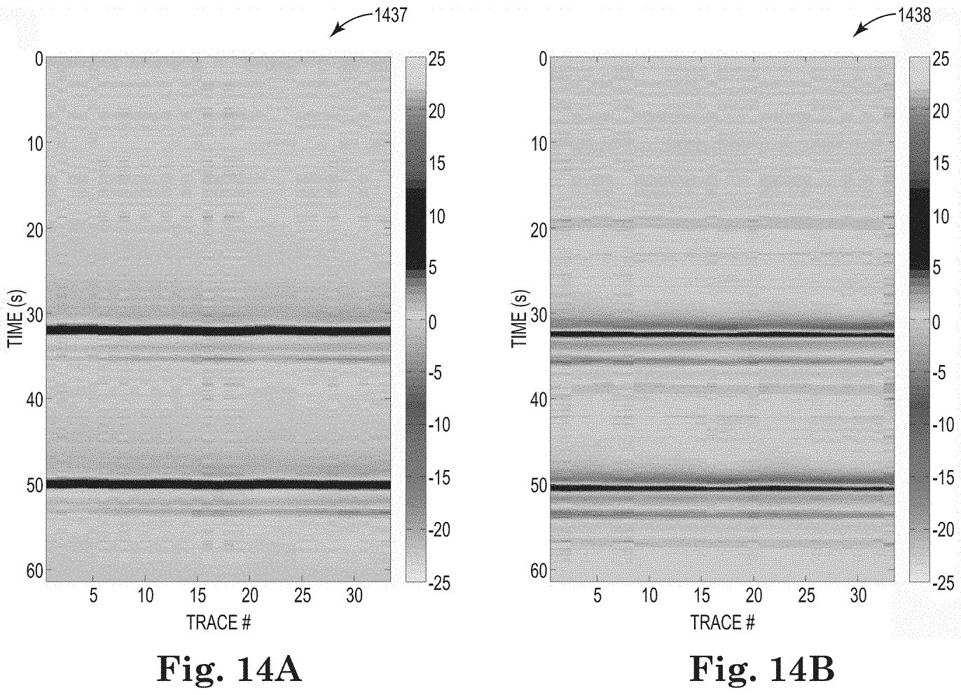

FIGS. 14A and 14B illustrate diagrams 1437 and 1438 of results of an example physical experiment for AC coupled accelerometer calibration. Diagrams 1437 and 1438 illustrates traces associated with measured AC coupled accelerometer data subsequent to the application of calibration parameters. For instance, FIG. 14A is more similar to FIG. 10A, which includes actual results, than FIG. 10A is to 9A, which includes predicted results. Similarly, FIG. 14B is more similar to FIG. 10B, which includes actual results, than FIG. 10B is to 9B, which includes predicted results. For instance, FIGS. 10A and 10B illustrates traces of data before corrections for variation in sensitivities and RC responses were applied, while FIGS. 14A and 14B illustrate traces after corrections have been applied. Diagram 1437 illustrates a trace associated with y component responses, while diagram 1438 illustrates a trace associated with z-component responses. In both diagrams 1437 and 1438, time is illustrated on the left vertical axis in seconds, a trace number, also known as a location of DC coupled accelerometers on a towed object, is illustrated on the horizontal axis in meters. Acceleration in millimeters per second squared is illustrated on the right vertical axes of diagrams 1437 and 1438 and is represented by changes in shading in diagrams 1437 and 1438.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments can provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
acquiring calibrated data from a direct current (DC) coupled accelerometer of a towed object;
interpolating the acquired calibrated data to a location of an alternating current (AC) coupled accelerometer of the towed object;
estimating a calibration parameter associated with the AC coupled accelerometer based on the interpolating; and
correcting for a sensitivity associated with the AC coupled accelerometer using the calibration parameter.

2. The method of claim 1, further comprising filtering the acquired calibrated data.

3. The method of claim 1, wherein acquiring the calibrated data comprises acquiring the calibrated data during a roll of the towed object.

4. The method of claim 1, wherein acquiring the calibrated data comprises acquiring the calibrated data during a typical seismic acquisition process.

5. The method of claim 1, wherein interpolating the acquired calibrated data to the location of the AC coupled accelerometer comprises interpolating an orientation angle deviation between the DC coupled accelerometer and the AC coupled accelerometer.

6. The method of claim 1, wherein estimating the calibration parameter comprises estimating a resistor-capacitor (RC) response of the AC coupled accelerometer.

7. The method of claim 1, wherein estimating the calibration parameter comprises estimating an orientation angle deviation between the DC coupled accelerometer and the AC coupled accelerometer.

8. The method of claim 1, wherein estimating the calibration parameter comprises estimating a different sensitivity associated with the AC coupled accelerometer.

9. The method of claim 2, wherein filtering the acquired calibrated data comprises filtering the acquired calibrated data using a low pass filter.

10. A system comprising:
a processing resource;
a memory resource coupled to the processing resource and comprising instructions executable by the processing resource to:
cause a portion of a towed object to roll;
acquire data from a DC coupled accelerometer calibrated during the roll;
low pass filter the data acquired from the calibrated DC coupled accelerometer;
determine an orientation angle deviation between the calibrated DC coupled accelerometer and an AC coupled accelerometer using the low pass filtered data acquired from the calibrated DC coupled accelerometer;
interpolate the orientation angle deviation to a location of an AC coupled accelerometer;
determine response data at the location of the AC coupled accelerometer based on the interpolated orientation angle deviation;
remove DC components of the response data;
low pass filter the response data;
estimate a plurality of calibration parameters associated with the AC coupled accelerometer using the low pass filtered data acquired from the calibrated DC coupled accelerometer and the low pass filtered response data; and
correct for a sensitivity associated with the AC coupled accelerometer using the estimated calibration parameter.

11. The system of claim 10, wherein the instructions executable to determine response data at the location of the AC coupled accelerometer comprise instructions executable to determine y-component and z-component response data at the location of the AC coupled accelerometer.

12. The system of claim 10, wherein the instructions are executable to remove the DC components of the response data by subtraction of a mean value of the low pass filtered data acquired from the calibrated DC coupled accelerometer.

13. The system of claim 10, wherein the instructions are executable to remove the DC components of the response data by high pass filtering the low pass filtered data acquired from the calibrated DC coupled accelerometer.

14. The system of claim 10, wherein the instructions executable to determine an orientation angle deviation between the AC coupled accelerometer and the DC coupled accelerometer using the estimated calibration parameter comprise instructions executable to determine the orientation angle deviation when the DC coupled accelerometer and the AC coupled accelerometer are separated by less than 10 meters.

15. The system of claim 10, wherein instructions are executable to determine the orientation angle deviation between the calibrated DC coupled accelerometer and the AC coupled accelerometer based on an arctangent of y-component and z-component response data within the low pass filtered data acquired from the calibrated DC coupled accelerometer.

16. The system of claim 10, wherein the instructions are executable to low pass filter data acquired from the calibrated DC coupled accelerometer and low pass filter response data with a filter that passes signals between approximately one and two Hertz.

17. The system of claim 10, further comprising:
a controller comprising the processing resource and the memory resource; and
a streamer communicatively coupled to the controller and housing the AC coupled accelerometer and the DC coupled accelerometer.

18. A non-transitory machine readable medium storing instructions executable by a processing resource to:
acquire data from a calibrated direct current (DC) coupled accelerometer of a towed object;
low pass filter the acquired data;
interpolate the acquired data to a location of an alternating current (AC) coupled accelerometer of the towed object;
remove a DC component from the interpolated data;
low pass filter the interpolated data with the DC component removed;
estimate a calibration parameter associated with the AC coupled accelerometer using the low pass filtered data acquired from the calibrated DC coupled accelerometer and the low pass filtered interpolated data; and
correct for a sensitivity associated with the AC coupled accelerometer the estimated calibration parameter.

19. The medium of claim 18, wherein the instructions are executable to low pass filter the acquired data and low pass filter the interpolated data with a filter that passes signals between approximately ten and fifteen Hertz.

20. The medium of claim 18, wherein the instructions executable to low pass filter the acquired data comprise instructions executable to remove acquired data associated with a particle motion sensor noise floor.

21. A method of generating a geophysical data product, the method comprising:
obtaining geophysical data;
processing the geophysical data to generate a seismic image, wherein processing the geophysical data comprises:
acquiring calibrated data from a direct current (DC) coupled accelerometer of a towed object;
interpolating the acquired calibrated data to a location of an AC coupled accelerometer of the towed object;
estimating a calibration parameter associated with the AC coupled accelerometer based on the interpolating; and
correcting for a sensitivity associated with the AC coupled accelerometer using the calibration parameter; and
recording the seismic image on one or more non-transitory machine-readable media, thereby creating the geophysical data product.
